(19) United States
(12) Patent Application Publication
(10) Pub. No.: US 2018/0306503 A1
(43) Pub. Date: Oct. 25, 2018

(54) HAY BALE DRYER

(71) Applicants: Emil Jacob Gulbranson, Vanderhoof (CA); Chandler Blain Gulbranson, Vanderhoof (CA)

(72) Inventors: Emil Jacob Gulbranson, Vanderhoof (CA); Chandler Blain Gulbranson, Vanderhoof (CA)

(21) Appl. No.: 15/957,275

(22) Filed: Apr. 19, 2018

Related U.S. Application Data
(63) Continuation-in-part of application No. 15/496,397, filed on Apr. 25, 2017.

(51) Int. Cl. F26B 21/00; F26B 3/06; F26B 9/10

(52) U.S. Cl. CPC F26B 21/004; F26B 21/001; F26B 9/10; F26B 3/06

(57) ABSTRACT

The present invention provides a hay bale dryer, comprising: a platform, the platform dimensioned to support the hay bale; a spike rack movably coupled to the platform, the spike rack having a plurality of spikes, each spike having a plurality of slots and each spike dimensioned to penetrate through the hay bale; a fan coupled to the spike rack and operative to blow air through the slots in the spikes, wherein the spike rack is raised to permit loading and unloading of the hay bale, and lowered to permit drying of the hay bale via the air blown through the spikes

### CROSS-REFERENCE TO RELATED APPLICATION

The present application is a continuation-in-part of U.S. patent application Ser. No. 15/496,397, filed Apr. 25, 2017, which is hereby incorporated by reference.

### FIELD OF THE INVENTION

The present specification relates generally to dryers for hay bales, and, in particular, to an air-injection drying system for one or more hay bales.

### BACKGROUND OF THE INVENTION

After harvesting, hay is stored in bales, which need to be below a specific moisture level (generally 12%) to prevent spoilage during storage. This is typically done by cutting the hay, then leaving it in the fields to dry prior to being baled. Under ideal conditions, cut hay starts at approximately 75% moisture, which is reduced to around 40% within the first 24 hours and to around 25% in the next 48. However, to get down to 12% typically requires another 72 hours. Therefore, a clear weather window for 5 days is required for harvesting hay. This creates a risk of the hay being exposed to further moisture prior to baling as a consequence of a change in weather patterns. Furthermore, hay left too long may become too dry, leading to a loss of leaves and a reducing harvest.

It would be preferable to harvest hay at a 25% moisture level, and then to dry the bales to the required moisture level thereafter. This would reduce the required weather window significantly, as well as enabling earlier field irrigation to reduce the chances of plants going dormant. However, drying hay bales presents a challenge. Hay bales are generally quite large in size (typically 3 feet by 4 feet by 8 feet) and drying the interior hay flakes through exterior drying means is difficult. Ideally, a drying process should penetrate the interior of the hay bale, as well as enabling reasonably rapid drying of high-moisture bales.

Accordingly, there remains a need for improvements in the art.

### SUMMARY OF THE INVENTION

In accordance with an aspect of the invention, there is provided an air injection hay bale dryer using spikes to penetrate the interior of the hay bale.

According to an embodiment of the invention, there is provided a hay bale dryer, comprising: a platform, the platform dimensioned to support the hay bale; a spike rack movably coupled to the platform, the spike rack having a plurality of spikes, each spike having a plurality of slots and each spike dimensioned to penetrate through the hay bale; a fan coupled to the spike rack and operative to blow air through the slots in the spikes, wherein the spike rack is raised to permit loading and unloading of the hay bale, and lowered to permit drying of the hay bale via the air blown through the spikes.

According to another embodiment of the invention, there is provided a hay bale drying system, comprising: a plurality of hay bale dryers, each hay bale dryer comprising: a platform, the platform dimensioned to support the hay bale; and a spike rack movably coupled to the platform, the spike rack having a plurality of spikes, each spike having a plurality of slots and each spike dimensioned to penetrate through the hay bale. The hay bale drying system further comprises a fan coupled to each of the hay bale dryers in line and operative to blow air through the slots in the spikes, wherein each spike rack is independently raised to permit loading and unloading of its respective hay bale, and lowered to permit drying of the hay bale via the air blown through the spikes.

According to another embodiment of the invention, there is provided a method of drying a hay bale located on a platform to a desired moisture level, comprising: lowering a spike rack movably coupled to the platform, the spike rack having a plurality of spikes, each spike having a plurality of slots and each spike dimensioned to penetrate through the hay bale; activating a fan coupled to the spike rack to blow air through the spikes; and raising the spike rack once the process is complete.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1A is a front elevation view of a hay bale dryer with the spike rack raised according to an embodiment;

FIG. 1B is a front elevation view of the hay bale dryer of FIG. 1A with the spike rack lowered;

FIG. 2A is an end elevation view of the hay bale dryer of FIG. 1A with the spike rack raised;

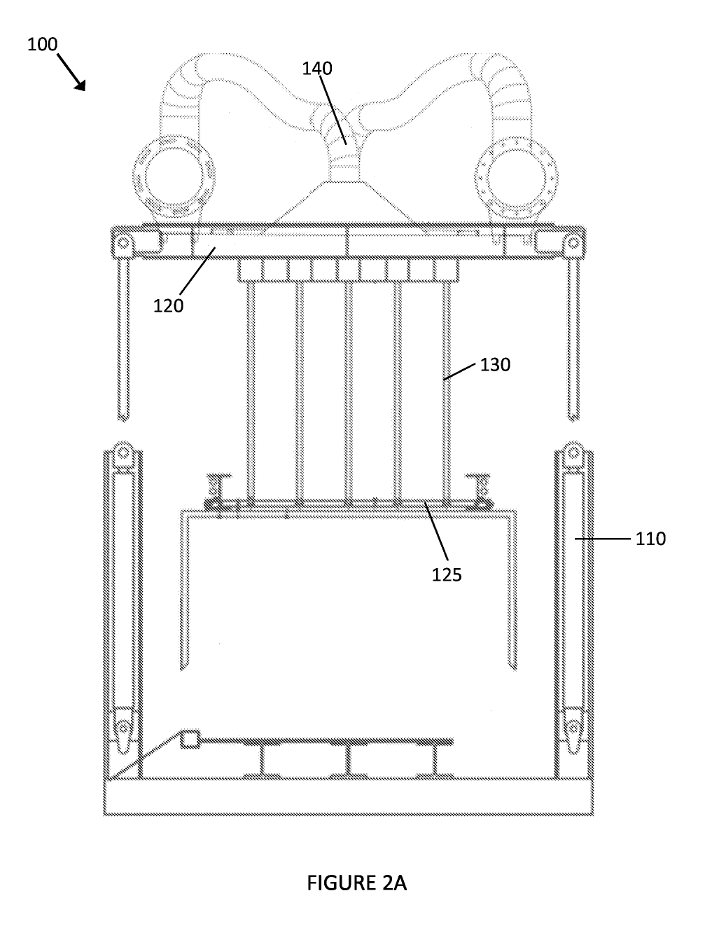

FIG. 2B is an end elevation view of the hay bale dryer of FIG. 1A with the spike rack lowered;

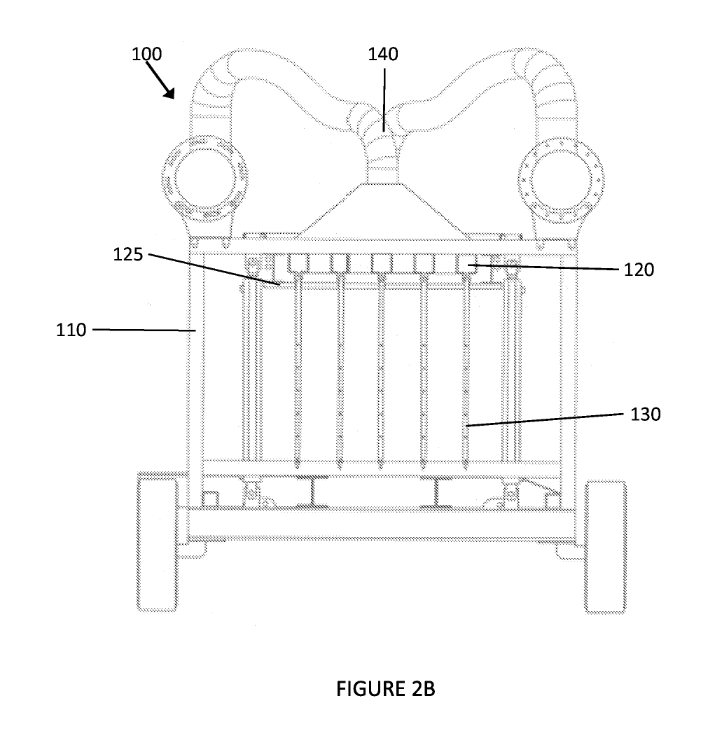

FIG. 3 is an elevation view of a spike with slots according to an embodiment;

FIG. 4 is a plan view of a hay bale platform according to an embodiment;

FIG. 5 is a plan view of a spike pattern according to an embodiment;

FIG. 6 is a plan view of a spike rack according to an embodiment;

FIG. 7 is a plan view of air duct piping for a spike rack according to an embodiment; and

FIG. 8 is a block diagram of multiple hay bale dryers connected according to an embodiment.

Like reference numerals indicated like or corresponding elements in the drawings.

### DETAILED DESCRIPTION OF THE EMBODIMENTS

The present invention is a dryer for hay bales and, in particular, to an air injection dryer for hay bales.

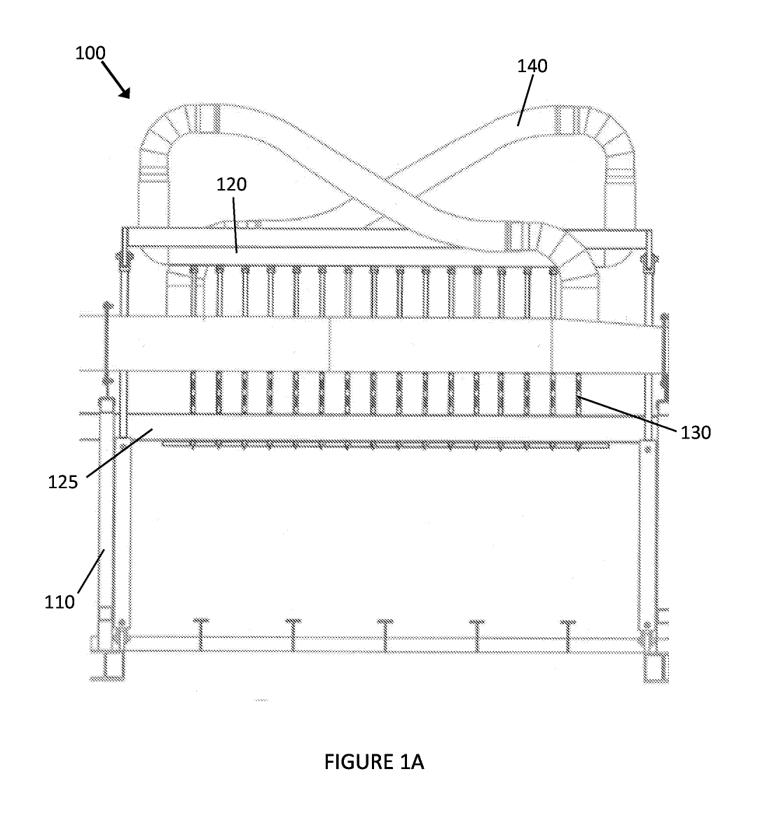

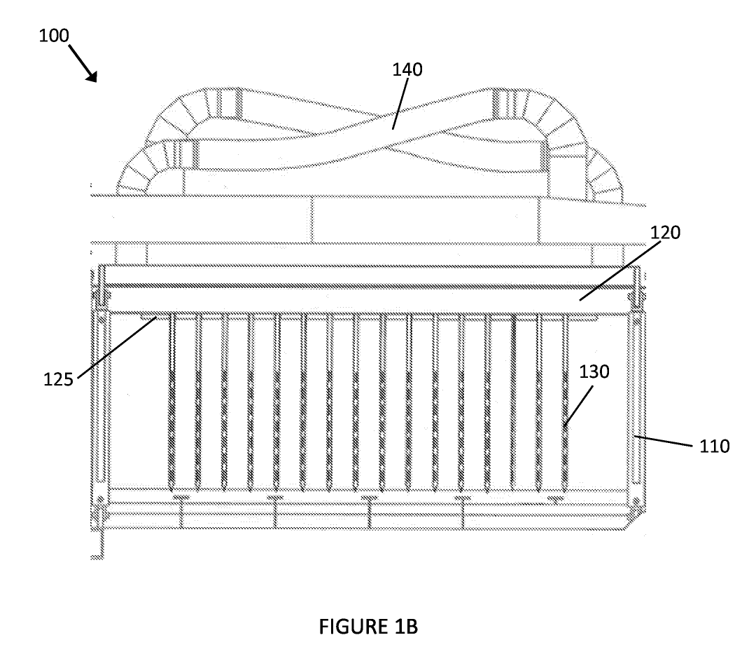

According to an embodiment as shown in FIGS. 1A and 1B, the dryer 100 consists of a platform 110 and a spike rack 120. Spike rack 120 may be raised to permit insertion of a hay bale (not shown) as in FIG. 1A, and may be lowered to perform the drying process, as in FIG. 1B. Each spike 130 in spike rack 120 is coupled via piping 140 to permit air to flow through the piping 140 into spike rack 120 and into each spike 130. Spike rack 120 may be raised and lowered by a hydraulic mechanism, and a spike guide 125 may be attached to the platform 110 to guide the spikes 130 into the hay bale. When lowered, the tips of spikes 130 should not contact the base of platform 110.

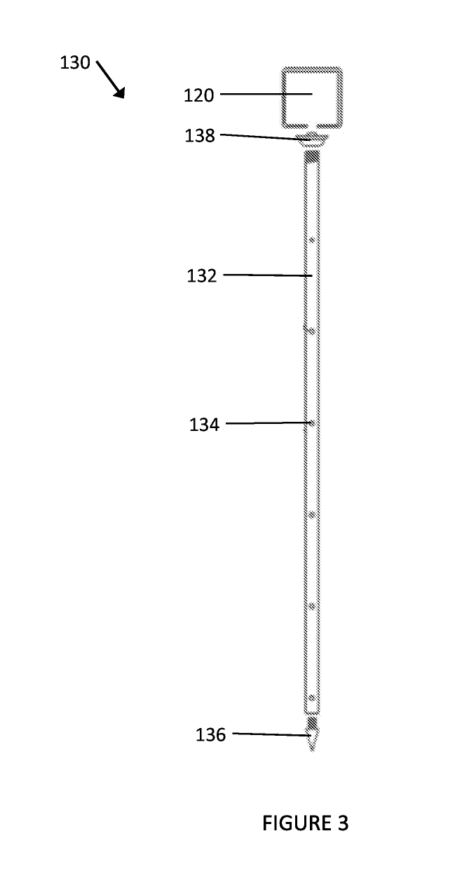

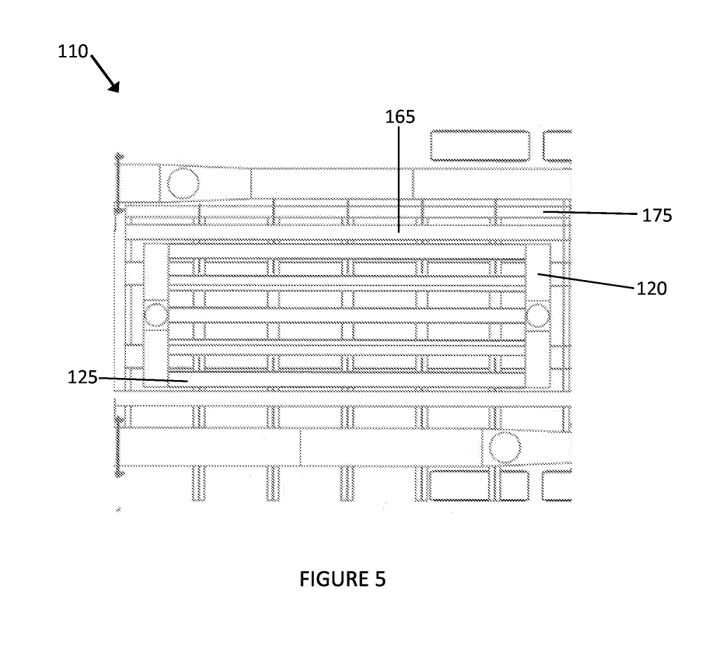

As shown in FIG. 3, each spike 130 may be formed from a body 132, with a number of slots 134. The number, spacing and size of the slots 134 is determined by the size of the bale, the estimated average size of the hay flakes within the bale (typically 5 to 6 inches) and the fan pressure and corresponding desired air flow output through the spike. As an example, for a 3×4×8 hay bale, spikes 130 are arranged in 5 staggered rows, in three rows of 16 and 2 rows of 15 (see pattern in FIG. 5), for 78 spikes 130, with 6 slots per spike 130. For other bale sizes, different configurations may be used. For example, a 3×3×8 may have only four rows of spikes, whereas a 4×4×8 bale may require longer spikes and more slots. The desired air flow of per bale, or per spike 130 will depend on the fan pressure and the size of the slots 134. As shown in FIG. 3, spike 130 may have a detachable tip 136 and a detachable connector 138 to spike rack 120, to simplify cleaning, however, spike 130 may alternatively be formed as a single unitary piece secured to spike rack 120.

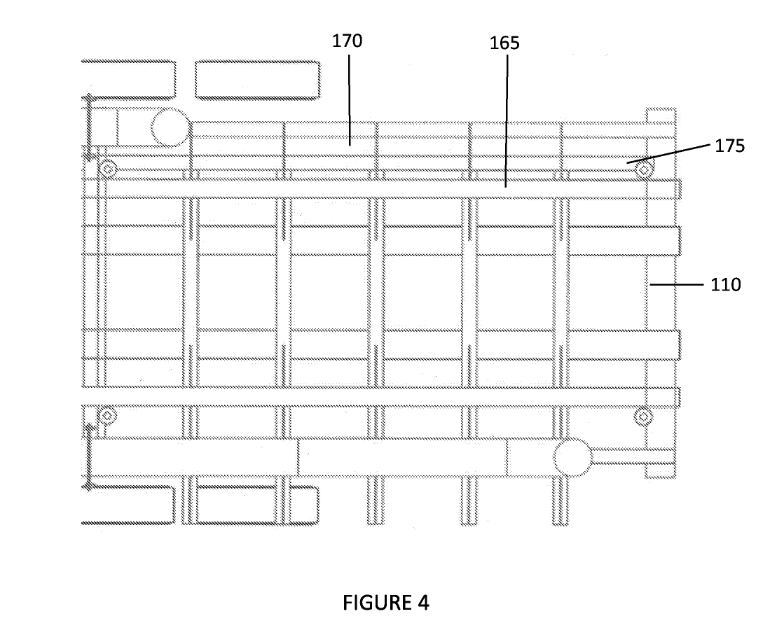

Referring to FIG. 4, a plan view of the platform 110 is provided. Platform 110 includes a bale trap 165 to support the hay bale with a front apron 170 for loading the bale. A bale guide 175 may be provided to align the bale on the platform 110 with the spike rack 120, as shown in FIG. 5.

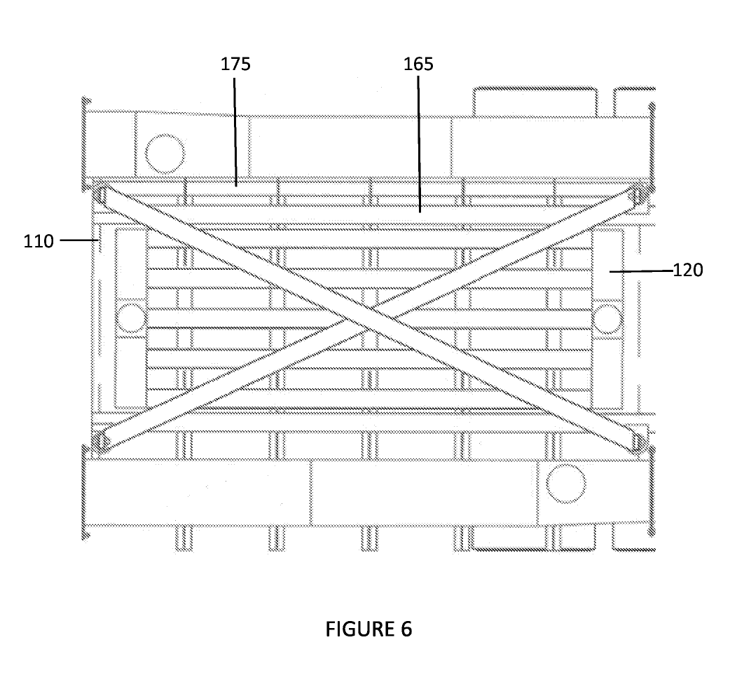

FIG. 5 provides a plan view of platform 110 and spike guide 125. As discussed above for a 3×4×8 bale, 78 spikes 130 are arranged in 5 staggered rows (3×16 and 2×15) disposed within the area defined by the front apron 170 and bale guide 175. FIG. 6 shows the full assembly of spike rack 120 overlaying the platform 110.

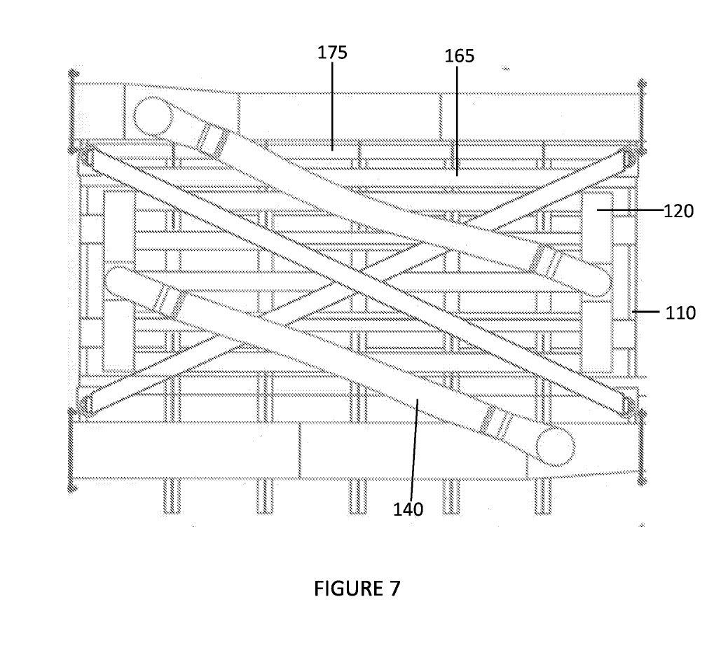

FIG. 7 shows a plan view of piping 140 overlaying spike rack 120 and platform 110. Piping 140 should be flexible, to permit the raising and lowering of spike rack 120 without compromising the integrity of piping 140. As shown, piping 140 has a Y-split to drive down two sides of spike rack 120, however, a single piping channel may be used, depending on the required airflow, number of spikes, and fan air pressure.

In operation, a hay bale is loaded onto platform 110 with spike rack 120 raised. Front apron 170 allows the hay bale to be manually pushed onto the bale trap 165, with bale guide 175 acting to keep the bale aligned to the platform 110 and spike rack 120.

Once the hay bale is loaded, spike rack 120 is lowered, with spike 130 passing through spike guide 125 and into the hay bale. As shown above, spikes 130 pass substantially through the hay bale, but do not contact the platform 110. With the spikes 130 in place, the drying process may begin.

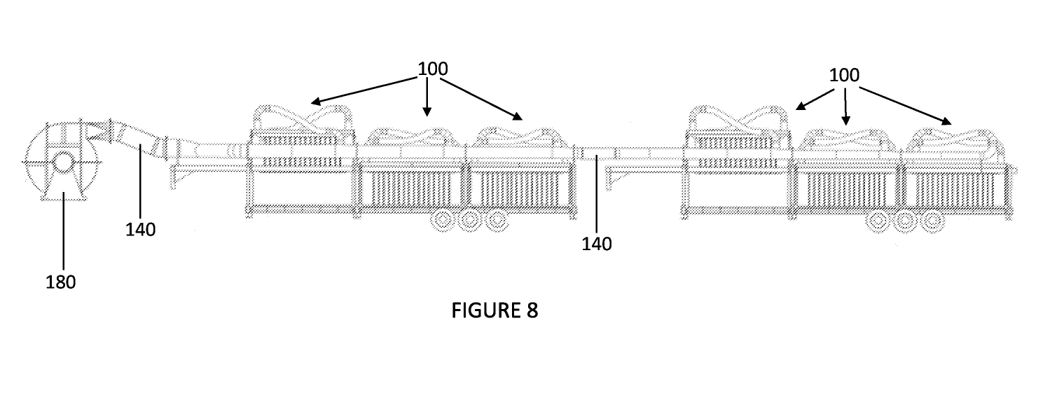

To dry the bale, a fan 180 (as shown in FIG. 8) is activated to force air through the piping 140 and into the spike rack 120 and out the slots 134 in the spikes 130 to dry the hay flakes within the hay bale. When the prescribed drying time for the drying process is completed, spike rack 120 may then be raised to remove the spikes and the dry hale bale pushed through the platform. A new bale may then be placed on the platform as described and the process repeated until all bales are dry.

Using a pressure blower fan 180 to dry 3×4×8 hay bales using the five-row spike pattern described above, it was found a hay bale could be dried from approximately 25%+ moisture to 12% moisture in 10 to 15 minutes. Thus, hay may be baled at 25%+ moisture and dried to 12% moisture via hay bale dryer 100, reducing the harvesting time by 1-3 days, depending on climate conditions.

It has been found that with an electric- or diesel-powered fan, it may be possible that the heat of operation of the fan 180 is sufficient to heat the air and remove moisture as a result, permitting the drying of hay bales without additional equipment. However, in particularly cool or humid climates, or when operating at night, it may be desirable to include a heater and/or a dehumidifier as part of the fan 180. Caution should be taken to avoid overheating the air as excessive heat may lead to spoilage of the hay bale.

Referring to FIG. 8, to increase efficiencies and throughput, a plurality of hay bale dryers 100 may be connected together in line to a single fan 180 (and, optionally, heater and dehumidifier). The total number of dryers 100 operable is determined by the power of fan 180. As shown, the dryers 100 are grouped in line. The piping 140 for each dryer 100 is then connected in parallel along the main line. In testing, it was found the six or more dryers may be connected per channel without a loss in performance, for a total of six or more dryers operating from a single fan 180 as an air source.

Alternatively, the plurality of hay bale dryers 100 may be connected to the fan 180 in using one or more Y-split pipes. The overall layout of fan 180 and dryers 100 may be determined by the volume of hay bale to be dried, the space available for loading bales and locating the dryers 100 and, as discussed above, the required airflow through the spikes 130 and power of fan 180.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A hay bale dryer, comprising:
a platform, the platform dimensioned to support the hay bale;
a spike rack movably coupled to the platform, the spike rack having a plurality of spikes, each spike having a plurality of slots and each spike dimensioned to penetrate through the hay bale; and
a fan coupled to the spike rack and operative to blow air through the slots in the spikes,
wherein the spike rack is raised to permit loading and unloading of the hay bale, and lowered to permit drying of the hay bale via the air blown through the spikes.

2. The hay bale dryer of claim 1, wherein the raising and lowering of the spike rack is performed by a hydraulic mechanism.

3. The hay bale dryer of claim 1, further comprising a heater coupled to the fan to heat the air prior to reaching the spike rack.

4. The hay bale dryer of claim 1, further comprising a dehumidifier coupled to the fan to remove moisture from the air prior to reaching the spike rack.

5. The hay bale dryer of claim 1, wherein the platform further comprises a spike guide aligned with the spikes such that each spike passes through the spike guide prior to penetrating the hay bale.

6. The hay bale dryer of claim 1, wherein each spike is detachably secured to the spike rack.

7. A hay bale drying system, comprising:
a plurality of hay bale dryers, each hay bale dryer comprising:
a platform, the platform dimensioned to support a hay bale; and
a spike rack movably coupled to the platform, the spike rack having a plurality of spikes, each spike having a plurality of slots and each spike dimensioned to penetrate through the hay bale; and
a fan coupled to each of the hay bale dryers in line and operative to blow air through the slots in the spikes,
wherein each spike rack is independently raised to permit loading and unloading of the hay bale, and lowered to permit drying of the hay bale via the air blown through the spikes.

8. The hay bale drying system of claim 7, wherein the raising and lowering of the spike rack is performed by a hydraulic mechanism.

9. The hay bale drying system of claim 7, further comprising a heater coupled to the fan to heat the air prior to reaching the spike racks.

10. The hay bale drying system of claim 7, further comprising a dehumidifier coupled to the fan to remove moisture from the air prior to reaching the spike racks.

11. The hay bale drying system of claim 7, wherein each platform further comprises a spike guide aligned with the spikes such that each spike passes through the spike guide prior to penetrating the hay bale.

12. A method of drying a hay bale located on a platform to a desired moisture level, comprising:
lowering a spike rack movably coupled to the platform, the spike rack having a plurality of spikes, each spike having a plurality of slots and each spike dimensioned to penetrate through the hay bale;
activating a fan coupled to the spike rack to blow air through the spikes; and
raising the spike rack once the drying process is completed.

13. The method of claim 12, wherein the desired moisture level is 12%.

14. The method of claim 12, wherein the hay bale has an initial moisture level of 25% or greater.

15. The method of claim 12, further comprising heating the air prior to the air reaching the spikes.

16. The method of claim 12, further comprising dehumidifying the air prior to the air reaching the spikes.

17. The method of claim 13, wherein the drying process is completed within a predetermined time frame.
